(19) United States
(12) Patent Application Publication
(10) Pub. No.: US 2007/0295361 A1
(43) Pub. Date: Dec. 27, 2007

(54) Spray device for a dishwasher and method of operation

(75) Inventors: Ramasamy Thiyagarajan, Bangalore (IN); Chetan Sharadchandra Tulapurkar, Bangalore (IN); Darren Lee Hallman, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/475,672

(22) Filed: Jun. 27, 2006

(51) Int. Cl. B08B 7/04; B08B 9/20; B08B 3/00; B08B 3/12

(52) U.S. Cl. 134/18; 134/198; 134/184; 134/172; 134/58 D; 134/56 D; 134/34; 134/25.2

(57) ABSTRACT

A spray device for a dishwasher is provided. The spray device includes a hub and a first spray arm mounted to the hub and having a first set of nozzles configured to introduce a solvent within the dishwasher in a first mode of operation. The spray device also includes a second spray arm mounted to the hub and having a second set of nozzles configured to introduce the solvent within the dishwasher in a second mode of operation, wherein the second spray arm is transverse to the first spray arm.

### BACKGROUND

The invention relates generally to dishwashers, and more particularly to a spray device for a dishwasher.

Various types of dishwashers are known and are in use. For example, a spray dishwasher used for domestic applications uses detergent dissolved in warm water that is sprayed to wash dishes stacked in racks. In particular, the spray dishwasher employs devices for spraying water such as a rotating spray arm that sprays water through multiple holes formed on the arm.

Typically, washability of the dishwasher is a function of parameters such as solvent flow rate, solvent coverage, temperature of the solvent, chemical energy, nozzle geometry, nozzle size, RPM of spray arm and jet force. The wash cycle of the dishwasher operation requires sufficient solvent flow rate, coverage, thermal and chemical energy. Further, the rinse cycle of the dishwasher operation requires coverage and an amount of solvent that is sufficient for removing detergent and excess food particles from the dishes. Thus, the rinse cycle requires a relatively lower solvent flow rate as compared to the wash cycle for maintaining the same coverage.

In a conventional dishwasher, a single hydraulic system is employed for all modes of operation of the dishwasher cycle such as pre-wash, wash and rinse cycles. Further, the solvent flow rate is same for all these modes of operation. As a result, such dishwashers utilize huge amounts of water and energy for washing the dishes.

Accordingly, a need exists for providing a dishwasher that utilizes substantially lower amounts of water and energy for washing the dishes. It would also be desirable to provide a spray device for the dishwasher that provides sufficient coverage for all modes of operation of the dishwasher while maintaining the low washing solvent usage.

### BRIEF DESCRIPTION

Briefly, according to one embodiment a spray device for a dishwasher is provided. The spray device includes a hub and a first spray arm mounted to the hub and having a first set of nozzles configured to introduce a solvent within the dishwasher in a first mode of operation. The spray device also includes a second spray arm mounted to the hub and having a second set of nozzles configured to introduce the solvent within the dishwasher in a second mode of operation, wherein the second spray arm is transverse to the first spray arm.

In another embodiment, a dishwasher is provided. The dishwasher includes a sump configured to store water for washing objects placed in the dishwasher, a spray device configured to spray the water from the sump over the objects and a pump coupled to the sump and configured to pump water contained in the sump to the spray device. The spray device includes a hub and a first spray arm mounted to the hub and having a first set of nozzles configured to introduce water for a wash cycle. The spray device also includes a second spray arm mounted to the hub and having a second set of nozzles configured to introduce water for a pre-wash cycle, or a rinse cycle, wherein the second spray arm is transverse to the first spray arm.

In another embodiment, a method of operating a spray device of a dishwasher is provided. The method includes introducing water within the dishwasher by a first spray arm of the spray device in a first mode of operation and introducing water within the dishwasher by a second spray arm of the spray device in a second mode of operation.

### DRAWINGS

These and other features, aspects, and advantages of the present invention will become better understood when the following detailed description is read with reference to the accompanying drawings in which like characters represent like parts throughout the drawings, wherein:

FIG. 1 is a side sectional view of a dishwasher having a spray device in accordance with embodiments of the present technique.

FIG. 2 illustrates an exemplary configuration of the spray device employed in the dishwasher of FIG. 1 in accordance with embodiments of the present technique.

FIG. 3 is a diagrammatical illustration of inlets for two arms of the spray device of FIG. 2 in accordance with embodiments of the present technique.

FIG. 4 is a diagrammatical illustration of tubing for supplying water to the two arms of the spray device of FIG. 2 in accordance with embodiments of the present technique.

FIG. 5 illustrates flow path of water within the first spray arm of the spray device of FIG. 2 in accordance with embodiments of the present technique.

FIG. 6 illustrates flow path of water within the second spray arm of the spray device of FIG. 2 in accordance with embodiments of the present technique.

FIG. 7 illustrates exemplary results for performance of existing dishwashers and the dishwasher of FIG. 1 with the spray device in accordance with embodiments of the present technique.

FIG. 8 illustrates exemplary results for coverage for a wash cycle through a first spray arm of the spray device of FIG. 2 in accordance with embodiments of the present technique.

FIG. 9 illustrates exemplary results for coverage for a rinse cycle through a second spray arm of the spray device of FIG. 2 in accordance with embodiments of the present technique.

FIG. 10 illustrates an exemplary operational cycle for the dishwasher of FIG. 1 in accordance with an embodiment of the present technique.

### DETAILED DESCRIPTION

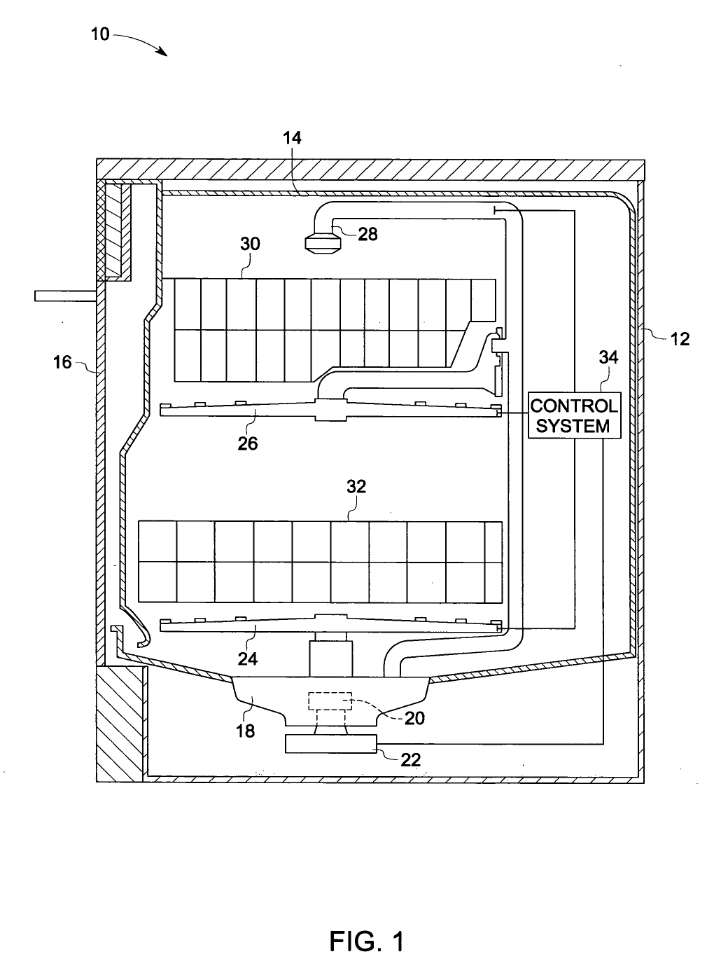

As discussed in detail below, embodiments of the present invention function to provide a dishwasher that utilizes substantially lower amounts of water and energy for washing the dishes. In particular, the present invention provides a spray device for the dishwasher that provides sufficient coverage for all modes of operation of the dishwasher while maintaining the low washing solvent usage. Referring now to the drawings, FIG. 1 is a side sectional view of a low water dishwasher 10 that is configured to wash dishes with a solvent such as water sprayed through a spray device. The dishwasher 10 includes an enclosing cabinet 12 and a tub 14 installed in the cabinet 12 to define a dish washing chamber. Further, the dishwasher 10 includes a door 16 installed in the front of the tub 14 to open or close the dish washing chamber and a sump 18 installed on the bottom center of the tub 14 to store washing water.

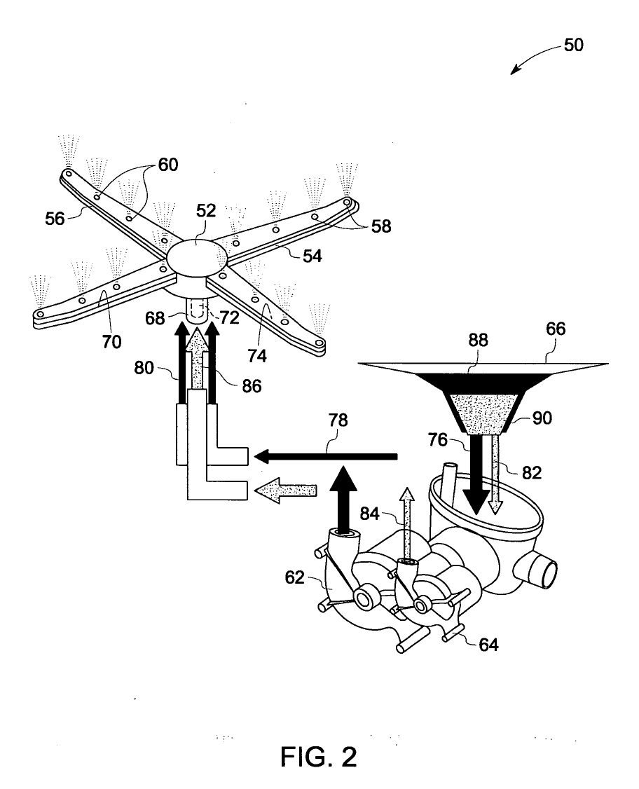

In addition, the dishwasher 10 includes a pump 20 that is in fluid communication with the sump 18 to pump washing water stored in the sump 18. A motor 22 is drivingly coupled to the pump 20 for driving the pump 20. Further, the dishwasher 10 includes spray devices such as represented by reference numerals 24, 26 and 28 for spraying the water received from the pump 20 over the dishes loaded in washing racks 30 and 32 within the tub 14. As illustrated, the spray devices 24, 26 and 28 may be located above or below the washing racks 30 and 32 depending upon a design of the dishwasher 10. In the illustrated embodiment, the spray devices 24, 26 and 28 include a dual spray arm configuration to spray water on the dishes during different modes of operation of the dishwasher 10. Further, a control system 34 is coupled to the spray devices 24, 26 and 28 for controlling the operation of the spray devices based upon a mode of operation of the dishwasher 10. The dual spray arm configuration of the spray devices 24, 26 and 28 will be described in detail below with reference to FIGS. 2-6.

FIG. 2 illustrates an exemplary configuration 50 of the spray device employed in the dishwasher 10 of FIG. 1. The spray device 50 includes a hub 52. A first spray arm 54 is mounted to the hub 52 and is configured to introduce a solvent such as water within the dish washing chamber 14 (see FIG. 1) in a first mode of operation of the dishwasher 10. Further, the spray device 50 includes a second spray arm 56 mounted to the hub 52 and configured to introduce water within the dish washing chamber 14 in a second mode of operation of the dishwasher 10. In the illustrated embodiment, the second spray arm 56 is transverse to the first spray arm 54. The term “transverse” is used herein to refer arrangements wherein the long dimensions of the spray arms are not aligned, i.e. where the first spray arm and the second spray arm extend from the hub along different radial axes. In the illustrated embodiment, the arms are disposed perpendicularly to one another; however, other configurations having different orientation of the first and second spray arms 54 and 56 may be envisaged.

Further, the first spray arm 54 includes a first set of nozzles 58 and the second spray arm 56 includes a second set of nozzles 60 for spraying water over the dishes within the dish washing chamber 14 during first and second modes of operation respectively. In one exemplary embodiment, the first mode of operation includes a wash cycle and the second mode of operation includes a rinse cycle or a pre-wash cycle.

The spray device 50 also includes a first pump 62 coupled to the first spray arm 54 and a second pump 64 coupled to the second spray arm 56. In operation, the first and second pumps 62 and 64 are in fluid communication with a sump 66 and are configured to pump washing water contained in the sump 66 for washing or rinsing cycles. In the illustrated embodiment, a flow rate of the first pump 62 is different than a flow rate of the second pump 64. In certain embodiments, the spray device 50 includes a single pump and a valve system (not shown) is employed for directing water from the pump to the first and second spray arms 54 and 56.

In operation, based upon a mode of operation of the dishwasher 10, the flow of water to the first and second spray arms 54 and 56 is controlled via the control system 34 (see FIG. 1). For example, during a wash cycle of the dishwasher 10, the first pump 62 is operated to pump the water from the sump 66 to the first spray arm 54 through a first inlet 68. In this exemplary embodiment, the spray device 50 includes a first channel 70 in fluid communication with the first inlet 68 and the first set of nozzles 58. Similarly, during a rinse cycle or a pre-wash cycle of the dishwasher 10, the second pump 64 is operated to pump the water from the sump 66 to the second spray arm 56 through a second inlet 72. Again, the spray device includes a second channel 74 in fluid communication with the second inlet 72 and the second set of nozzles 60. The flow path of water for the wash cycle is indicated by reference numerals 76, 78 and 80 and the flow path of water for the pre-wash or a rinse cycle is indicated by reference numerals 82, 84 and 86. It should be noted that the rinse cycle or the pre-wash cycle requires a relatively lower water flow rate as compared to the wash cycle. Therefore the water level in the sump 66 may be maintained at different levels such as represented by reference numerals 88 and 90 for the wash cycle and the pre-wash or rinse cycle respectively. Thus, the sump 66 may be designed based upon a desired flow rate and cavitation.

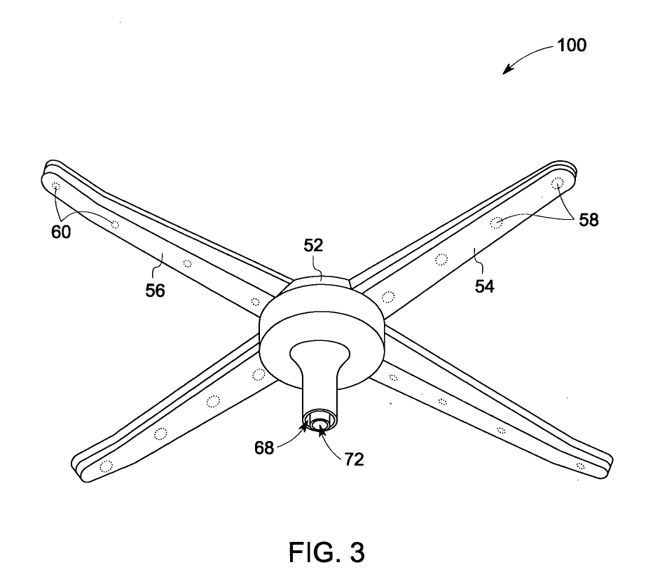

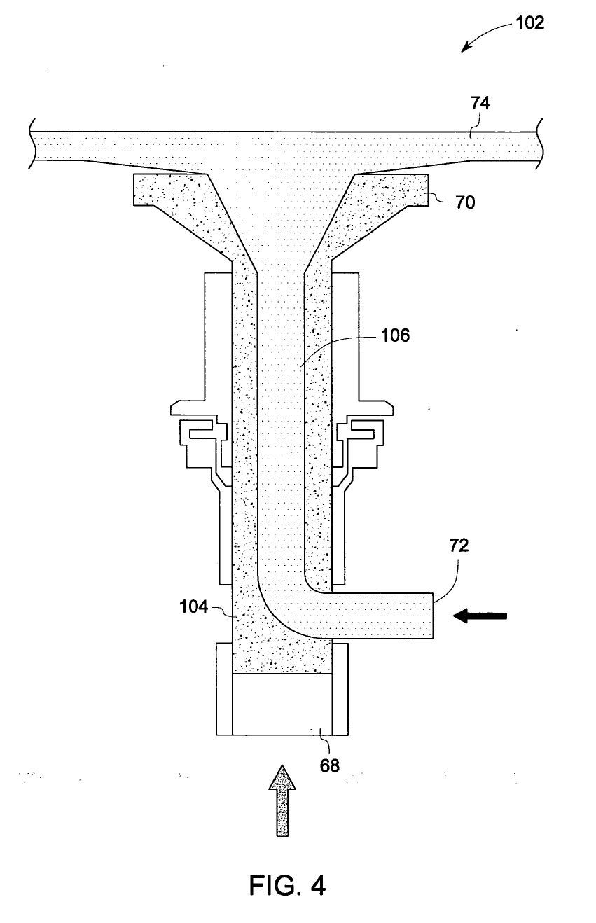

FIG. 3 is a diagrammatical illustration of an exemplary configuration 100 of first and second inlets 68 and 72 for two arms 54 and 56 of the spray device 50 of FIG. 2. As illustrated, the first and second inlets 68 and 72 are disposed in a concentric configuration. Based upon a mode of operation of the dishwasher 10 (see FIG. 1) water may be pumped to the first or second inlets 68 and 72 for wash or pre-wash/rinse cycles. Further, the flow of water through the first and second inlets 68 and 72 is directed to the first and second set of nozzles 58 and 60 through the first and second channels 70 and 74 as illustrated in FIG. 4.

FIG. 4 is a diagrammatical illustration of tubing 102 for supplying water to the two arms 54 and 56 of the spray device 50 of FIG. 2. In the illustrated embodiment, during wash operation, the water from the first pump 62 (see FIG. 2) is provided to the spray device 50 via inlet 68 and through tubing 104. Similarly, during rinse or pre-wash operation, the water from the second pump 64 (see FIG. 2) is provided to the spray device 50 via inlet 72 and through tubing 106. The first and second pumps 62 and 64 may be selectively operated to provide the water through the tubing 104 and 106 based upon the mode of operation of the dishwasher 10. In certain embodiments, a valve system (not shown) may be employed to divert the water through the tubing 104 or 106. Further, the flow of water is directed to the first and second set of nozzles 58 and 60 though first and second channels 70 and 74 respectively. In the illustrated embodiment, the first and second channels 70 and 74 include concentric tubes within the spray device 50 and the corresponding mating component such as a hub line filter (not shown).

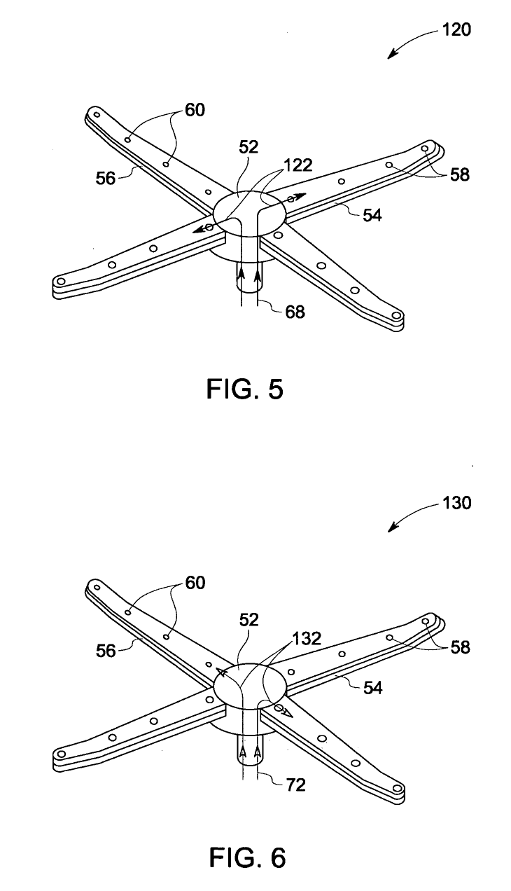

FIG. 5 illustrates flow path 120 of water within the first spray arm 54 of the spray device 50 of FIG. 2. As illustrated, during the wash cycle, water enters the first inlet 68 and is directed to the first set of nozzles 58 of the first spray arm 54 as represented by reference numeral 122. This flow of water 122 is then sprayed on the dishes for a pre-determined period of time of the wash cycle. It should be noted that the direction of the water jet controls the direction of rotation of spray arm 54 along with its rotations per minute (RPM). In certain embodiments, a spherical nozzle design is employed for providing flexibility for changing the angle of water jets. FIG. 6 illustrates flow path 130 of water within the second spray arm 56 of the spray device 50 of FIG. 2. In this exemplary embodiment, during the pre-wash cycle or the rinse cycle, water enters the second inlet 72 and is directed to the second set of nozzles 60 of the second spray arm 56 as represented by reference numeral 132. Again, this flow of water 132 is sprayed on the dishes for a pre-determined period of time of the pre-wash or rinse cycle. In this exemplary embodiment, the first and second inlets 68 and 72 and the first and second set of nozzles 58 and 60 may be designed based upon a desired wash performance.

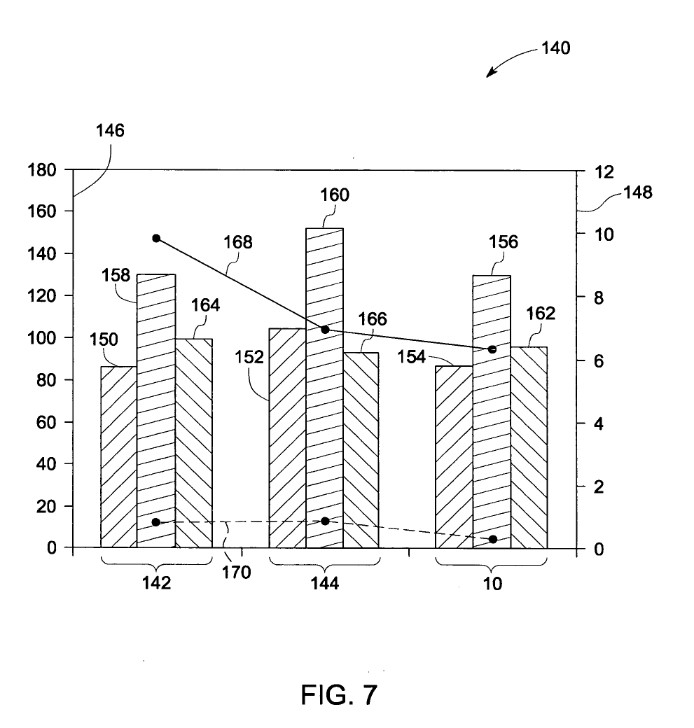

FIG. 7 illustrates exemplary results 140 for performance of existing dishwashers 142 and 144 and the dishwasher 10 of FIG. 1 with the spray device 50 of FIG. 2. In the illustrated embodiment, the ordinate axis 146 is representative of cycle time (minutes), water temperature (° F.) and wash index (%). Further, the ordinate axis 148 is representative of water consumption (Gallons) and energy consumption (kWh). The total cycle time for the existing dishwashers 142 and 144 is represented by reference numerals 150 and 152. Further, the total cycle time of the dishwasher 10 with the spray device 50 is represented by reference numeral 154. As can be seen, the total cycle time 154 of the dishwasher 10 is comparable to the total cycle time 150 of the dishwasher 142 and is substantially less than the total cycle time 152 of the dishwasher 144.

Further, water temperature 156 in the dishwasher 10 is relatively lesser than water temperature 158 or 160 in the existing dishwashers 142 and 144. In addition, a wash index 162 of the dishwasher 10 with the spray device 50 is comparable with a wash index 164 of the existing dishwasher 142 and is relatively higher than a wash index 166 of the existing dishwasher 144. In this exemplary embodiment, the wash index for each of the dishwashers 142, 144 and 10 is estimated through a washability test. Typically, food items are applied on dishes about 24 hours prior to the washability test and are then washed in the dishwasher. Further, the washed dishes are graded at the end of the cycle for estimating the wash index. The dishes are graded on a scale of 0, 3 and 8, 0 where 0 is assigned to a perfectly clean dish, 3 is assigned to a dish where any remaining soil can be flicked off with relatively less effort and 8 being assigned to a dish where any remaining soil regardless of its size cannot be flicked off the dish or can be flicked of but leaves a mark on the dish. The grading is performed for all the dishes washed in the dishwasher and the wash index is estimated by the following equation:

$$Wash Index = 100 ( 1 - \frac{a}{8 N} ) \qquad ( 1 )$$

Where: a is summation of all assigned points; and

N is number of pieces in the load for the cycle of the dishwasher.

In the illustrated embodiment, the water consumption (Gallons) by the dishwashers 142, 144 and 10 is represented by profile 168 and the energy consumption (kWh) by the dishwashers 142, 144 and 10 is represented by profile 170. As can be seen, the water consumption by the dishwasher 10 having the spray device 50 is relatively lesser than that of the existing dishwashers 142 and 144. Additionally, the energy consumption by the dishwasher 10 is substantially lesser than the energy consumption by the existing dishwashers 142 and 144. Beneficially, the dishwasher 10 with the spray device 50 having the dual spray arm configuration operates at a relatively lower water and energy consumption while maintaining the performance at a desired level. In particular, the selective operation and control of the dual spray arms 54 and 56 (see FIG. 2) of the spray device 50 during different modes of operation of the dishwasher facilitates reduction in water and energy consumption of the dishwasher 10.

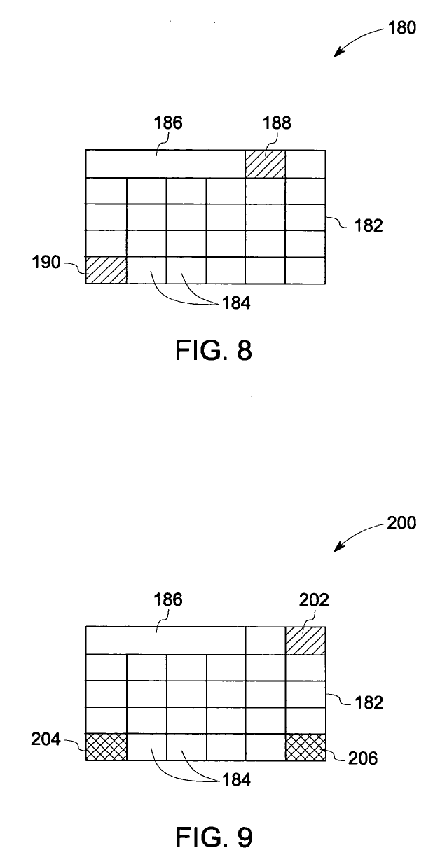

FIG. 8 illustrates exemplary results 180 for coverage for a wash cycle through the first spray arm 54 of the spray device 50 of FIG. 2. The results 180 are obtained from a tomato juice coverage test for the wash cycle of the dishwasher 10. In the illustrated embodiment, dishes are placed on a dish rack 182 at different locations such as represented by reference numeral 184. The dishes are covered by tomato juice and the dishwasher is operated for a pre-determined time period of the wash cycle. In certain embodiments, a fog system 186 may be employed for soaking the loose particles from the dishes. In the illustrated embodiment, the dishes placed on locations 188 and 190 have relatively less coverage as compared to the dishes placed on other locations on the dish rack 182.

FIG. 9 illustrates exemplary results 200 for coverage for a rinse cycle through the second spray arm 56 of the spray device 50 of FIG. 2. As with the embodiment of FIG. 8, the results 200 are obtained from the tomato juice coverage test for the rinse cycle of the dishwasher 10. As can be seen, the dishes placed on locations 202, 204 and 206 have relatively less coverage as compared to the dishes placed on other locations on the dish rack 182. Advantageously, the dual spray arm configuration of the spray device 50 employed in the dishwasher 10 provides sufficient coverage for all modes of operation of the dishwasher 10 while maintaining the low washing solvent usage.

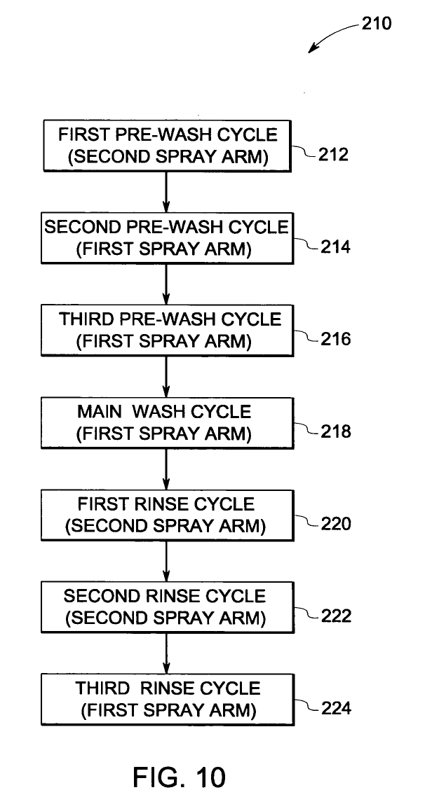

As described above, the spray arms 54 and 56 (see FIG. 2) of the spray device 50 are selectively operated based upon a desired mode of operation of the dishwasher 10. In certain embodiments, the first and second spray arms 54 and 56 may be operated simultaneously to achieve a desired flow rate of the water within the dishwasher 10. FIG. 10 illustrates an exemplary operational cycle 210 for the dishwasher 10 of FIG. 1. Typically, the dishwasher 10 employs a series of pre-wash, wash and rinse cycles having a preset operation time for washing the dishes. As described above, the spray device 50 employed in the dishwasher may be controlled based upon a desired operational cycle of the dishwasher 10. In particular, the first and second spray arms 54 and 56 may be operated based upon the operational cycle of the dishwasher.

In the illustrated embodiment, the operational cycle 210 includes a first pre-wash cycle 212 for removing loose particles from the dishes. For this cycle 212, the second spray arm 56 having the second set of nozzles 60 is employed for spraying water on the dishes. Next, the first spray arm 54 having the first set of nozzles 58 is operated for a second and a third pre-wash cycle, as represented by reference numerals 214 and 216. Further, the first spray arm 54 is operated for washing the dishes during a main wash cycle 218. In addition, the rinse cycle employs the second spray arm 56 for first and second rinse cycles 220 and 222 and the first spray arm 54 for a third rinse cycle 224.

As will be appreciated by one skilled in the art based upon a desired flow rate for each of these cycles, the first and second spray arms 54 and 56 may be controlled by the control system 34 (see FIG. 1) thereby using an optimum amount of water and energy for the operational cycle 210 of the dishwasher 10. As illustrated, the exemplary cycle 210 includes three pre-wash cycles, a main wash cycle and three rinse cycles having a pre-determined running time. However, the dishwasher 10 may employ a greater or lesser number of such cycles. Again, based upon the number of cycles and the desired flow rate of water, the first and second spray arms 54 and 56 may be selectively controlled during operation of the dishwasher 10. In certain embodiments, the first and second spray arms 54 and 56 may be operated simultaneously to achieve a desired flow rate. In certain other embodiments, either one of the spray arms 54 and 56 may be operated for all the cycles.

The various aspects of the method described hereinabove have utility in dishwashers. As noted above, the dishwasher employs a spray device having a dual spray arm configuration that utilizes substantially lower amounts of water and energy for washing the dishes. Further, the spray device described above provides sufficient coverage for all modes of operation of the dishwasher while maintaining the low washing solvent usage.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A spray device for a dishwasher, comprising:
a hub;
a first spray arm mounted to the hub and having a first set of nozzles configured to introduce a solvent within the dishwasher in a first mode of operation; and
a second spray arm mounted to the hub and having a second set of nozzles configured to introduce the solvent within the dishwasher in a second mode of operation, wherein the second spray arm is transverse to the first spray arm.

2. The spray device of claim 1, wherein the first mode of operation comprises a wash cycle and the second mode of operation comprises a rinse cycle, or a pre-wash cycle.

3. The spray device of claim 1, further comprising a first pump coupled to the first spray arm and a second pump coupled to the second spray arm.

4. The spray device of claim 3, wherein a flow rate of the first pump is different than a flow rate of the second pump.

5. The spray device of claim 3, further comprising a sump coupled to the first and second pumps for providing the solvent in the first and second modes of operation.

6. The spray device of claim 1, further comprising first and second inlets mounted on the hub.

7. The spray device of claim 6, comprising a first channel in fluid communication with the first inlet and the first set of nozzles and a second channel in fluid communication with the second inlet and the second set of nozzles.

8. The spray device of claim 7, wherein the first and second channels are disposed in a concentric configuration.

9. The spray device of claim 1, comprising a pump coupled to the first and second spray arms and a valve configured to direct the solvent from the pump to the first and second spray arms.

10. The spray device of claim 1, further comprising a control system configured to control the operation of the first and second spray arms based upon a mode of operation of the dishwasher.

11. A dishwasher, comprising:
a sump configured to store water for washing objects placed in the dishwasher;
a spray device configured to spray the water from the sump over the objects, wherein the spray device comprises:
a hub;
a first spray arm mounted to the hub and having a first set of nozzles configured to introduce water for a wash cycle; and
a second spray arm mounted to the hub and having a second set of nozzles configured to introduce water for a pre-wash cycle, or a rinse cycle, wherein the second spray arm is transverse to the first spray arm; and
a pump coupled to the sump and configured to pump water contained in the sump to the spray device.

12. The dishwasher of claim 11, further comprising a control system configured to control the operation of the first and second spray arms based upon a mode of operation of the dishwasher.

13. The dishwasher of claim 11, further comprising a valve system configured to direct water from the pump to the first and second spray arms.

14. The dishwasher of claim 11, comprising a first pump coupled to the first spray arm and configured to pump water for the wash cycle and a second pump coupled to the second spray arm and configured to pump water for the pre-wash cycle, or the rinse cycle.

15. The dishwasher of claim 14, wherein a flow rate of the first pump is relatively higher than a flow rate of the second pump.

16. The dishwasher of claim 11, further comprising first and second inlets disposed on the hub and configured to introduce water into the first and second spray arms.

17. The dishwasher of claim 16, further comprising a first channel in fluid communication with the first inlet and the first set of nozzles and a second channel in fluid communication with the second inlet and the second set of nozzles, wherein the first and second channels are disposed in a concentric configuration.

18. The dishwasher of claim 11, wherein the sump is designed based upon a desired flow rate and cavitation.

19. A method of operating a spray device of a dishwasher, comprising:
introducing water within the dishwasher by a first spray arm of the spray device in a first mode of operation; and
introducing water within the dishwasher by a second spray arm of the spray device in a second mode of operation.

20. The method of claim 19, wherein the first mode of operation comprises a wash cycle and the second mode of operation comprises a pre-wash cycle, or a rinse cycle of the dishwasher.

21. The method of claim 20, comprising controlling a flow rate of water for the first and second modes of operation of the dishwasher.

22. The method of claim 21, comprising directing water from a first pump into the first spray arm in the wash cycle and directing water from a second pump into the second spray arm in the pre-wash cycle, or the rinse cycle of dishwasher.

23. The method of claim 21, comprising directing water from a pump into the first and second spray arms through a valve system.

24. The method of claim 19, comprising operating the first and second spray arms simultaneously for achieving a desired flow rate of water within the dishwasher.
